(19) United States
(12) Patent Application Publication
(10) Pub. No.: US 2023/0372181 A1
(43) Pub. Date: Nov. 23, 2023

(54) MOTORIZED SKELETAL TRACTION DEVICE

(71) Applicant: University of Utah Research Foundation, Salt Lake City, UT (US)

(72) Inventors: Brandon A. SHERROD, Salt Lake City, UT (US); Trevor SCHWEHR, Salt Lake City, UT (US); Andrew ADAMS, Salt Lake City, UT (US); Sterling AVERETT, Salt Lake City, UT (US); Jeewon HA, Salt Lake City, UT (US); Simon KAHLE, Salt Lake City, UT (US); Derek MITCHELL, Salt Lake City, UT (US); Seth POLEVOI, Salt Lake City, UT (US); Andrew MERRYWEATHER, Salt Lake City, UT (US); Marcus Dennis MAZUR, Salt Lake City, UT (US)

(21) Appl. No.: 18/114,157

(22) Filed: Feb. 24, 2023

Related U.S. Application Data
(60) Provisional application No. 63/344,770, filed on May 23, 2022.

(51) Int. Cl. A61H 1/02

(52) U.S. Cl. CPC A61H 1/0222; A61H 2201/123; A61H 2201/1607; A61H 2201/1664; A61H 2203/0456; A61H 2201/5023

(57) ABSTRACT

A motorized cervical traction device comprises an inferior base configured to attach to a patient support (such as an operating table or gurney), a superior base spaced apart from the inferior base along a cranial/caudal direction, and a set of linear actuators extending between the inferior base and the superior base. The superior base includes an attachment point configured to enable mechanical coupling of a load sensor and a patient head attachment (e.g., Gardner-Wells device or Mayfield skull clamp) to the superior base. In use, the device provides real-time load sensing capability and can apply distraction via extension of the linear actuators to a preset load (force control) or displacement (position control). The device also includes a flexion/extension mechanism that enables rotational positioning of the linear actuators relative to the inferior base along and enables control of the flexion/extension angle of the applied traction.

### CROSS-REFERENCE TO RELATED APPLICATIONS

This application claims priority to and the benefit of U.S. Provisional Application No. 63/344,770, filed May 23, 2022, the entirety of which is incorporated herein by reference.

### BACKGROUND

### Technical Field

This disclosure relates to motorized skeletal traction devices and related methods of use.

### Related Technology

The incidence of spinal cord injury (SCI) is approximately 54 cases per one million people in the United States, or about 17,810 new cases each year, with cervical injuries comprising 54.5% of SCIs. Subaxial cervical spine fractures are the most common injuries and have an associated SCI rate of 15%-27%. In acute distraction-type cervical bony injuries, particularly facet dislocations, manual traction may be used to achieve mechanical stability and spinal cord decompression.

Conventional methods of cervical traction utilize head attachment devices such as the Gardner-Wells device, which consists of tongs with skull pins, or the Mayfield skull clamp. The head attachment device is used in conjunction with a series of pulleys and weights to achieve traction force along the axis of the cervical spine. However, such weight-and-pulley traction methods lack safeguards to prevent over-traction or weights being manipulated inadvertently. Moreover, conventional hanging-weight traction approaches require a large frame that limits efficient patient transport (e.g., for radiologic studies or operative intervention).

Accordingly, there is an ongoing need for improved devices and methods for providing cervical traction.

### SUMMARY

In one embodiment, a skeletal traction device comprises an inferior base configured to attach to a patient support (such as an operating table or gurney), a superior base spaced apart from the inferior base along a cranial/caudal direction, and a set of linear actuators extending between the inferior base and the superior base. The linear actuators are configured to extend so as to increase the distance of the superior base from the inferior base. That is, the linear actuators extend along the cranial/caudal direction to push the superior base away from the inferior base. The superior base includes an attachment point configured to enable mechanical coupling of a patient head attachment (e.g., Gardner-Wells device or Mayfield skull clamp) to the superior base such that, in use, extension of the linear actuators applies cervical traction to a patient.

Examples of skeletal traction devices are described herein as “cervical traction devices” suitable for use in applying cervical traction to a patient. It will be understood, however, that the same components and operating principles may be utilized to provide skeletal traction in other applications, such as tibial traction or other non-cervical applications. For example, the head attachment may be replaced with a leg attachment or other anatomical attachment appropriate for the desired traction procedure. The embodiments described herein are therefore not limited to cervical traction unless specified as such.

The cervical traction devices described herein can beneficially provide one or more improvements over the conventional approach to cervical traction. Such improvements include, but are not limited to: safety mechanisms that prevent under- or over-distraction of the cervical spine; real-time force measurement and/or actuator position sensing; more granular control over applied traction force; more precise force application; greater versatility and/or precision in traction vector orientation (e.g., more control over flexion/extension angle and/or lateral bending angle); simplified operator setup (e.g., capable of being carried by a single user and no requirement for attachment of a separate traction frame apart from the attachment to the patient support); a minimal overall footprint; and/or the ability to provide for effective patient transport during use (e.g., for imaging procedures or operative interventions).

The cervical traction devices described herein can be used wherever cervical traction of a patient is desired. Examples include facet dislocation injuries (bilateral or unilateral), halo-gravity traction (e.g., for pediatric deformity), discectomy distraction (e.g., during cervical spine surgery), and halo traction (e.g., for treating a patient with a hangman's fracture).

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 illustrates a conventional approach to cervical traction based on a weight and pulley assembly;

FIGS. 2A-2B illustrate an improved approach to cervical traction utilizing an embodiment of a cervical traction device as disclosed herein;

FIGS. 3A-3D illustrate various views of a cervical traction device as disclosed herein;

FIGS. 4A and 4B are force vs. time curves for an embodiment of the disclosed cervical traction device tested to 60 pounds (FIG. 4A) and to 85 pounds (FIG. 4B) of traction against an extension spring;

FIG. 4C illustrates results of cadaveric mechanical testing, showing force (pounds) and actuator motor extension (mm) versus time up to 70 pounds (311 N) of traction applied in 10 pound (45 N) increments; and

FIG. 5 illustrates radiographic cervical images from intact cadaver testing comparing motorized traction (left image) and conventional traction (right image) at 100 pounds of force.

### DETAILED DESCRIPTION

### Conventional Cervical Traction

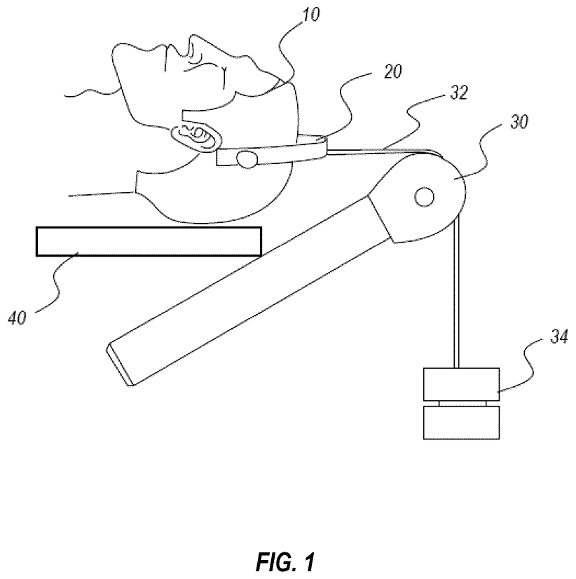

FIG. 1 illustrates the conventional approach to cervical traction based on a weight and pulley assembly. As shown, a patient head attachment 20 is attached to the patient 10 and the patient 10 is supported on a patient support 40 (e.g., an operating room table or gurney). The head attachment 20 is attached to a cable 32 which passes over pulley 30 and is attached to a set of weights 34. The effect of gravity on the weights 34 provides traction to the patient, with the magnitude of the traction force being governed by the amount of weight attached to the cable 32.

The conventional assembly has several limitations. The assembly lacks safety mechanisms to prevent under- or over-distraction of the cervical spine. For example, inadvertent manipulation of the weights 34 (e.g., from accidental bumping) can disrupt the intended traction force and/or orientation. Further, the conventional arrangement lacks safeguards for release of the applied weight, such as if the head attachment 20 were to slip from its proper position on the patient 10.

In addition, the granularity of the applied traction force is limited to the granularity of the weight stack and therefore typically lacks desired levels of precision. It is also difficult to adjust flexion/extension angle and/or lateral bending angle with such conventional systems. Moreover, the pulley and weight arrangement does not allow for safe patient transport during use. That is, it is unsafe for the weight system to freely sway while the patient 10 and patient support 40 are transported.

### Cervical Traction Device Overview

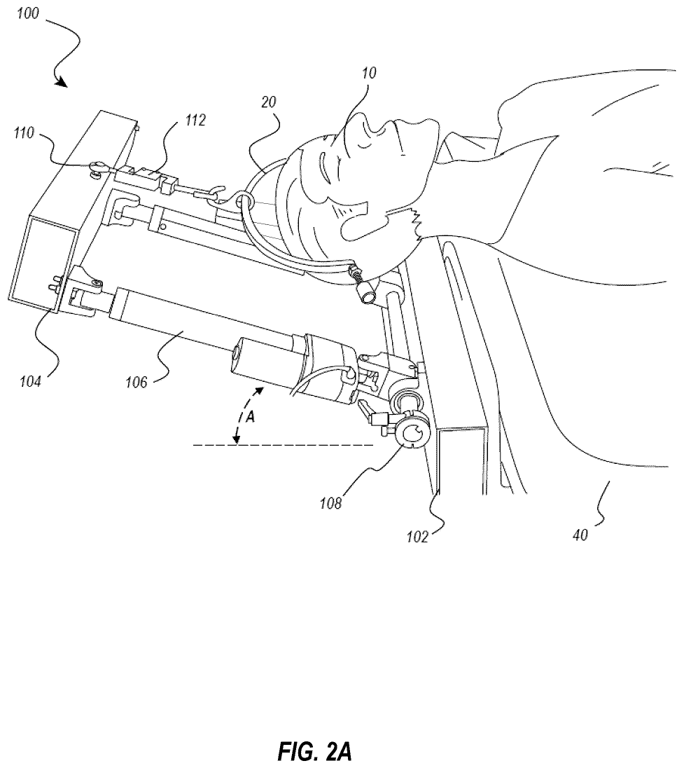

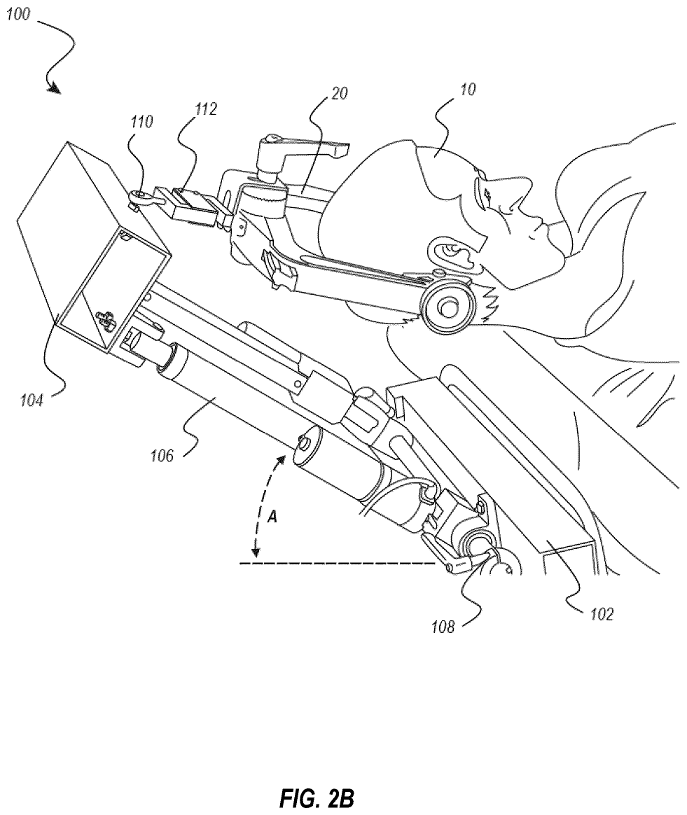

FIGS. 2A-2B illustrate an improved approach to cervical traction utilizing an embodiment of a cervical traction device 100 as disclosed herein. FIG. 2A illustrates a patient 10 with a patient head attachment 20 (in this case, a Gardner-Wells device). FIG. 2B illustrates a patient 10 with a patient head attachment 20 (in this case, a Mayfield skull clamp). In either case, the head attachment 20 is mechanically coupled to the cervical traction device 100 such that operation of the cervical traction device 100 applies a traction force to the cervical spine, as described in more detail below.

The head attachment 20 may comprise any suitable head attachment device known in the art. Examples include, but are not limited to, a Gardner-Wells device and a Mayfield skull clamp as in the illustrated embodiments. The Gardner-Wells device is described in more detail in U.S. Pat. No. 3,604,412, which is incorporated herein by reference. The Mayfield skull clamp is described in more detail in U.S. Pat. Nos. 4,169,478; 6,629,982; and 7,229,451, each of which is incorporated herein by reference.

As illustrated, the cervical traction device 100 includes an inferior base 102, a superior base 104 spaced apart from the inferior base 102 along an cranial/caudal direction (i.e., spaced “upward” from the inferior base 102), and a set of linear actuators 106 extending between the inferior base 102 and the superior base 104. The linear actuators 106 are configured to extend so as to increase the distance of the superior base 104 from the inferior base 102. That is, the linear actuators 106 extend along the cranial/caudal direction to push the superior base 104 away from the inferior base 102.

The inferior base 102 is configured to attach to the patient support 40. Any suitable means of attachment may be utilized. Various operating room tables, gurneys, and other patient supports are known in the art, and may include standard features allowing for attachment of the inferior base 102. Non-limiting examples for attaching the inferior base 102 to the patient support 40 include bolting, clamping, threaded engagement, other suitable forms of attachment, and combinations thereof. In use, because the inferior base 102 is immobile relative to the patient support 40, extension of the linear actuators 106 drives the superior base 104 away from the patient support 40.

The superior base 104 includes an attachment point 110 configured to enable mechanical coupling of the patient head attachment 20 to the superior base 104. The term “mechanically coupled,” and similar variations, refers to an attachment between two components (either direct or indirect) through which mechanical forces can be transmitted between the two components. For example, with respect to the superior base 104 and the head attachment 20, these components may be mechanically coupled via direct connection of the head attachment 20 to the superior base 104. Alternatively, as shown in FIG. 2A, one or more cables, rods, and/or other intermediate components can be disposed between the superior base 104 and the head attachment 20 to enable the mechanical coupling of these components.

The attachment point 110 can include any suitable means that enables mechanical coupling of the head attachment 20 (or associated rods, cables, etc.) to the superior base 104. Non-limiting examples include one or more through holes to enable bolting or screwing to the superior base 104, clamping mechanisms, threaded connections, other suitable fastening means known in the art, and combinations thereof. A single attachment point 110 is typically sufficient, but alternative embodiments can include multiple attachment points. As shown, a load sensor 112 may be disposed between the superior base 104 and the head attachment 20 as part of the mechanical coupling between these components. The load sensor 112 may be any suitable sensor or set of sensors known in the art that can measure an applied axial force. Non-limiting examples include strain gauge-based load cells, pneumatic load cells, and/or hydraulic load cells.

The illustrated embodiment includes a pair of laterally spaced linear actuators 106. The term “laterally spaced,” as used herein, means spaced along a medial/lateral direction substantially parallel to the coronal plane. This arrangement has been found to provide effective cervical traction. In addition, the spacing between the linear actuators 106 creates a “window” that allows for imaging of the cervical spine of the patient without interference from the linear actuators 106 or other components of the cervical traction device 100. Although presently preferred embodiments comprise a pair of linear actuators 106, other embodiments may include alternative arrangements of linear actuators. For example, some embodiments may include a single linear actuator or more than two linear actuators.

The illustrated embodiment includes a flexion/extension mechanism 108 that enables rotational positioning of the linear actuators 106 relative to the inferior base 102 along a sagittal plane. That is, the flexion/extension mechanism 108 enables the user to adjust the angle “A” of the linear actuators 106 relative to the inferior base 102 (and thus relative to the patient support 40). For example, FIG. 2B shows that the angle “A” is greater (and thus provides greater cervical flexion) than in FIG. 2A.

The flexion/extension mechanism 108 beneficially provides greater versatility in the degree of cervical flexion/extension for the patient during the application of cervical traction. The flexion/extension mechanism 108 also enables the user to readily make flexion/extension adjustments without requiring manipulation of a large frame assembly. The user can simply position the device 100 at the desired flexion/extension angle and then lock the flexion/extension mechanism 108. The flexion/extension angle “A” can be selected to provide patient cervical flexion of about 0 degrees to about 45 degrees, for example, though other settings can be utilized depending on particular application needs.

In some embodiments, the flexion/extension mechanism 108 is configured for manual adjustment. Additionally, or alternatively, the flexion/extension mechanism 108 can be motorized such that the angle “A” is adjustable via motorized control.

### Cervical Traction Device Details

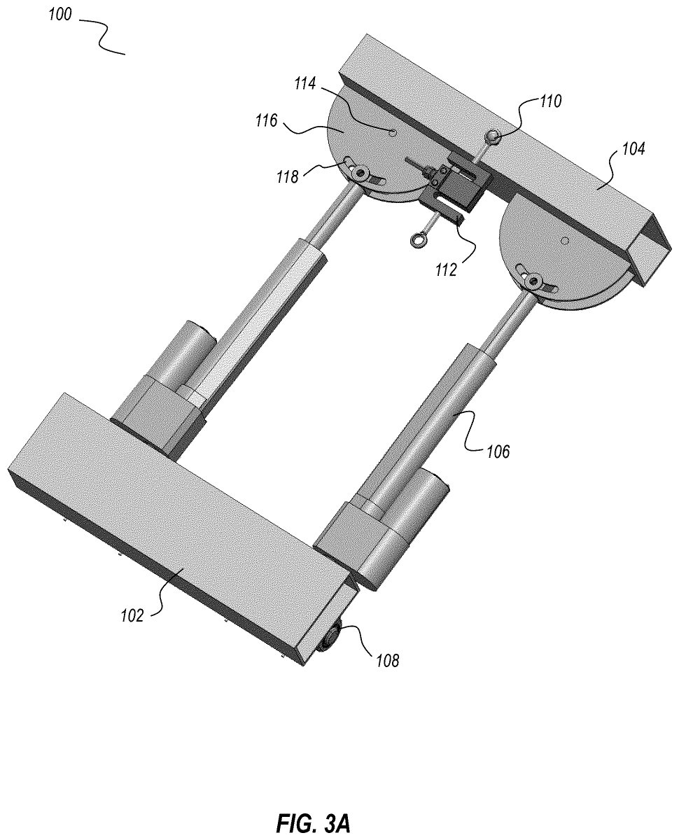

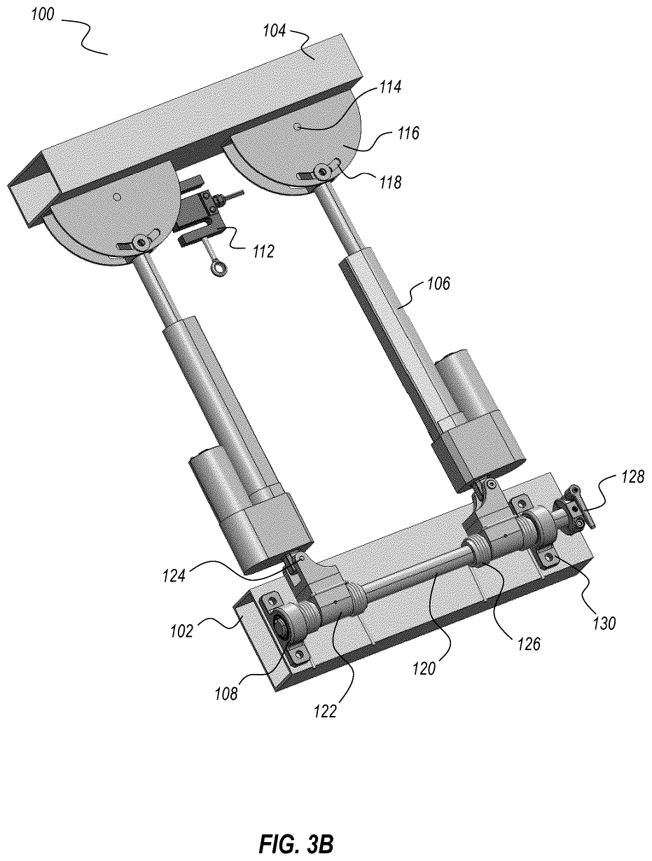

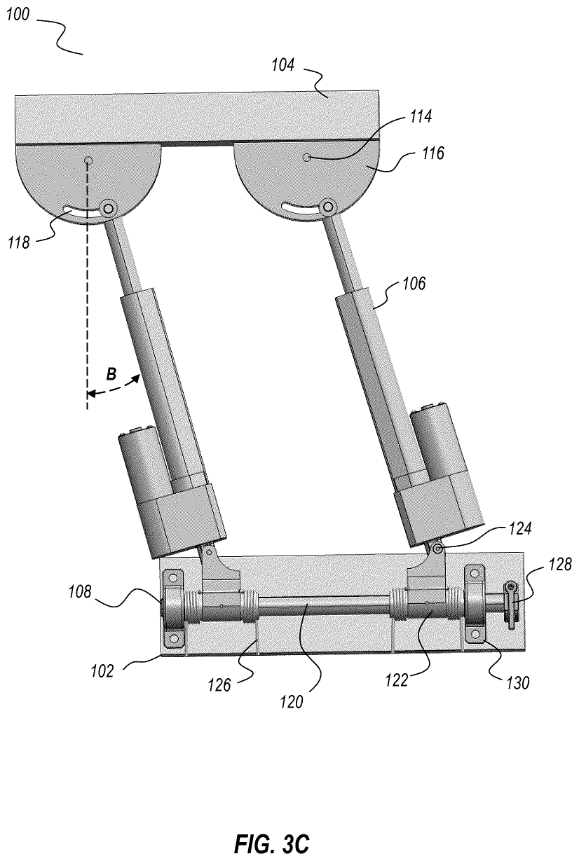

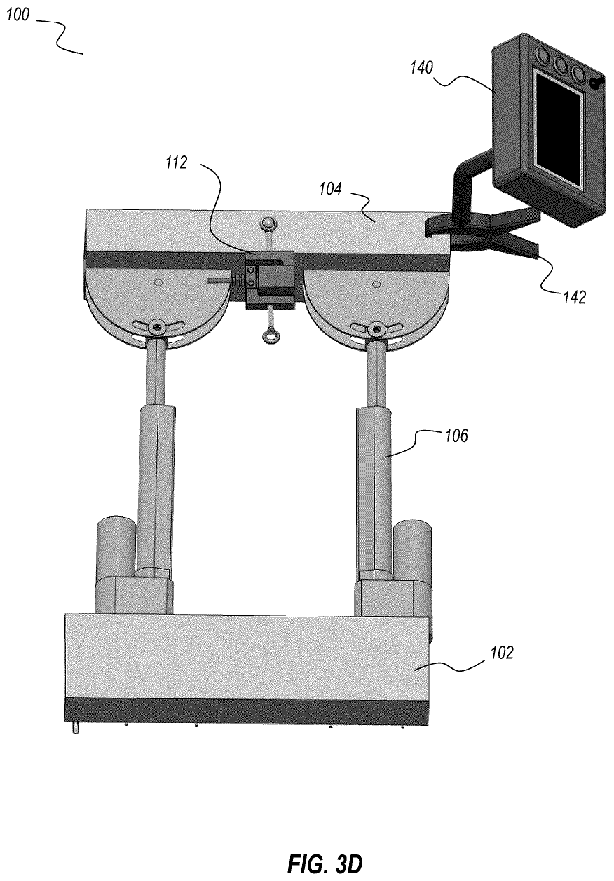

FIGS. 3A-3D illustrate various views of another configuration of the cervical traction device 100. FIG. 3A is an anterior perspective view, FIG. 3B is a posterior perspective view, FIG. 3C is a posterior view showing a lateral bending adjustment, and FIG. 3D is an anterior view showing a controller 140 associated with the cervical traction device 100.

As best shown in FIG. 3B, the linear actuators 106 are attached to the superior base 104 via superior joints 114 and the opposite ends of the linear actuators 106 are attached to the inferior base 102 via inferior joints 124. The superior joints 114 allow for lateral rotation (i.e., rotation along or parallel to the coronal plane) of the superior base 104 relative to the linear actuators 106 and the inferior joints 124 allow for lateral rotation (i.e., rotation along or parallel to the coronal plane) of the inferior base 102 relative to the linear actuators 106. The superior joints 114 and inferior joints 124 thus function to enable lateral bending adjustments.

FIG. 3C (load sensor 112 removed for clarity) illustrates the cervical traction device 100 adjusted to provide lateral bending according to lateral bending angle “B.” The lateral bending angle “B” can be selected to provide lateral bending of about 0 degrees to about 15 degrees (either direction), for example, though other lateral bending angles may be utilized according to particular application needs. By way of example, lateral bending configurations may be useful for unilateral facet injuries.

As shown in FIGS. 3A-3D, the linear actuators 106 are connected to the respective superior joints 114 via a pivot bracket 116. The pivot brackets 116 include an arcuate slot 118 disposed inferior to the superior joint 114. The arcuate slot 118 enables access to the underlying portions of the associated linear actuator 106 at different angles of lateral bending. A locking clamp or other locking mechanism can be utilized to lock the position of the linear actuators 106 relative to the pivot brackets 116. For example, once these components are positioned at a desired angle of lateral bending, a locking clamp extending through the arcuate slot 118 and engaging with the underlying portion of the linear actuator 106 can be tightened or otherwise actuated to lock the relative position of the linear actuator 106 and the pivot bracket 116.

As best illustrated in FIG. 3B, the flexion/extension mechanism 108 can comprise a shaft 120. The linear actuators 106 can be attached to respective mounts 122 that include a bore through which the shaft 120 passes. Rotation of the shaft 120 corresponds to rotation of the mounts 122 and therefore rotation of the linear actuators 106 relative to the inferior base 102. The shaft 120 and corresponding bores of the mounts 122 can be keyed or otherwise mechanically configured to enable corresponding rotation.

The illustrated flexion/extension mechanism 108 also includes a flexion/extension lock 128 for locking the shaft 120 and thereby locking the flexion/extension angle. The lock 128 may comprise a locking clamp and/or other locking mechanism suitable for preventing rotation as are known in the art. The shaft 120 can be attached to the inferior base 102 via one or more shaft supports 130 and/or through other suitable attachment means.

The flexion/extension mechanism 108 can include one or more torsion springs 126 configured to bias the rotational position of the shaft 120 toward a default rotational position. The default rotational position can be full flexion (e.g., to counter gravity during adjustment of the flexion/extension angle). Alternatively, the default rotational position can be any other desired flexion/extension position.

FIG. 3D illustrates a controller 140 associated with the cervical traction device 100. The controller 140 can include a user interface (UI) enabling the user to interact with the controller 140 and the components of the cervical traction device 100 connected to the controller 140. The illustrated controller 140 is attached to the other components of the cervical traction device 100 via clamp 142. In other embodiments, the controller 140 can be attached through other means, can be unattached, or can be directly integrated to some components of the cervical traction device 100 (e.g., with the superior base 104 or the inferior base 102).

The controller 140 can be communicatively coupled to the load sensor 112, the motors powering the one or more linear actuators 106, the motor(s) powering the flexion/extension mechanism 108, where applicable, and/or other sensors (e.g., positional sensors for measuring linear actuator displacement). The controller 140 can be configured to receive load signals from the load sensor 112 and to control force and/or displacement of the one or more linear actuators 106. For example, the controller 140 can be configured to operate with force-based control (e.g., to obtain a selected traction force) and/or with position-based control (e.g., to obtain a selected displacement) based on feedback received from the relevant sensor(s).

The controller 140 can be utilized to implement one or more safety features of the device 100. For example, the controller 140 can be configured as a proportional-integral-derivative (PID) controller to effectively limit under- or over-distraction.

The controller 140 can additionally or alternatively be configured with an anti-slip feature that functions to lock the position of the linear actuators 106 upon detecting a change in force exceeding a predetermined safety threshold. For example, the controller 140 can be configured to actively read the load sensor 112 when the linear actuators 106 are moving and/or if the load sensor 112 registers a force above a minimum threshold (e.g., 10 pounds). The controller 140 can read the load sensor 112 at a specified sampling rate (e.g., every 0.5 s). If a change in force exceeds a certain safety threshold rate (e.g., a change greater than 5 pounds from one sample to the next), the controller 140 can execute a stop operation to prevent further movement of the linear actuators 106. The controller 140 can also display an associated notice and/or provide a confirm/continue message via the UI.

The linear actuators 106 are preferably locking linear actuators. That is, the linear actuators 106 are preferably configured to maintain position when not actively under actuation to prevent unwanted retraction. This also provides additional safety during use of the device 100. For example, during unexpected power outage, the applied cervical traction will not suddenly fail and release. The linear actuators 106 may include a manual retraction/release feature to allow the user to release applied traction in such situations if desired.

In use, the device 100 can provide traction forces ranging from 1 pound to 200 pounds or more. For example, the device 100 can provide at least 80 pounds of traction force, such as up to about 200 pounds of traction force. Other examples include 90, 100, 110, 120, 130, 140, 150, 160, 170, 180, or 190 pounds, or a range using any of the foregoing values as endpoints. Because the traction force is applied via the linear actuators 106, the device 100 also beneficially enables the user to control the rate at which the traction force is applied. For example, the device 100 can be configured to provide a gradual onset with a relatively slower increase in applied force that then increases. Other variations in the rate of traction force application may also be utilized. The device 100 also enables measurement of the force/time history of the applied traction force. In contrast, conventional manual traction is essentially limited to a step function according to each weight manually added.

### Additional Controller Details

A controller (e.g., controller 140) can include one or more processors and computer-readable media such as computer memory stored on one or more hardware storage devices. The computer memory may store computer-executable instructions that when executed by one or more processors cause various functions to be performed, such as the acts recited herein. The term “controller” is used synonymously herein with “computer” or “computer system.”

Computer-readable media can include any media that can be accessed by a general purpose or special purpose computer system. Physical computer-readable storage media includes RAM, ROM, EEPROM, optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and the like.

The controller may be interconnected to one or more other computing systems via one or more network connections. Network connections may include, but are not limited to, connections via wired or wireless Ethernet, cellular connections, or even computer to computer connections through serial, parallel, USB, or other connections. The controller may be included in a distributed system environment in which local and remote computer systems, which are linked (either by hardwired data links, wireless data links, or by a combination of hardwired and wireless data links) through a network, both perform tasks. In a distributed system environment, program modules may be located in both local and remote memory storage devices.

The controller may have input hardware and software user interfaces to facilitate user interaction. For example, the controller may be configured to operate with a keyboard, mouse, touchpad, touchscreen, camera, manual actuator (e.g., buttons, switches, dials) for allowing a user to input data into the controller. In addition, various software user interfaces may be available. Examples of software user interfaces include graphical user interfaces, text command line-based user interface, function key or hot key user interfaces, and the like.

### WORKING EXAMPLES

Extension Spring Testing

An extension spring was implemented into the system to simulate a patient's neck. The spring was placed between the load cell and the frame of the device, allowing for higher application of forces. The spring used was a 0.227 GA steel extension spring (Everbuilt) with a maximum capability of 342 pounds (1500 N) and an associated maximum deflection of 2.3 in (5.8 cm). Data were collected during tests up to 85 pounds (378 N) to investigate the clinical viability of the device.

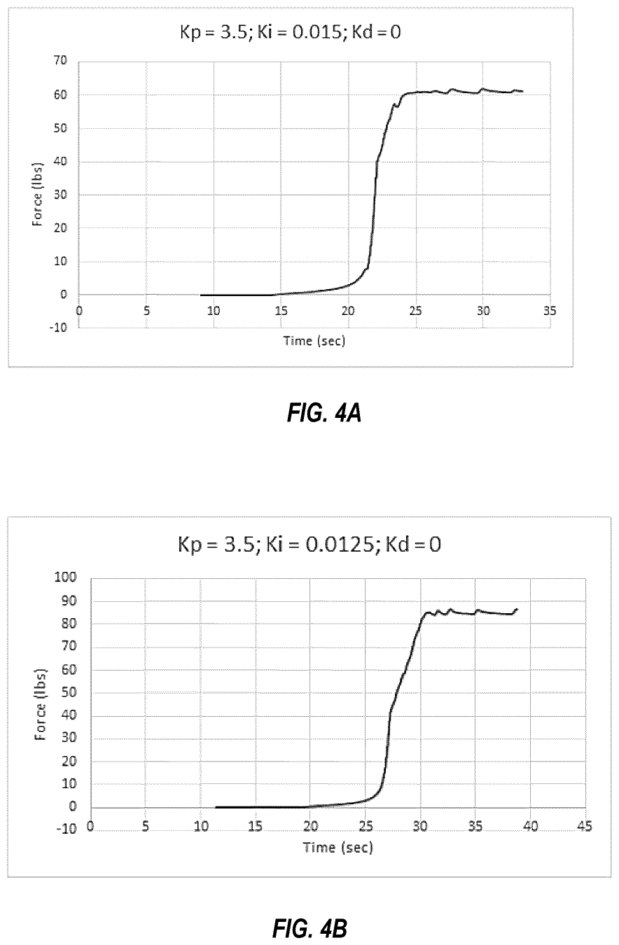

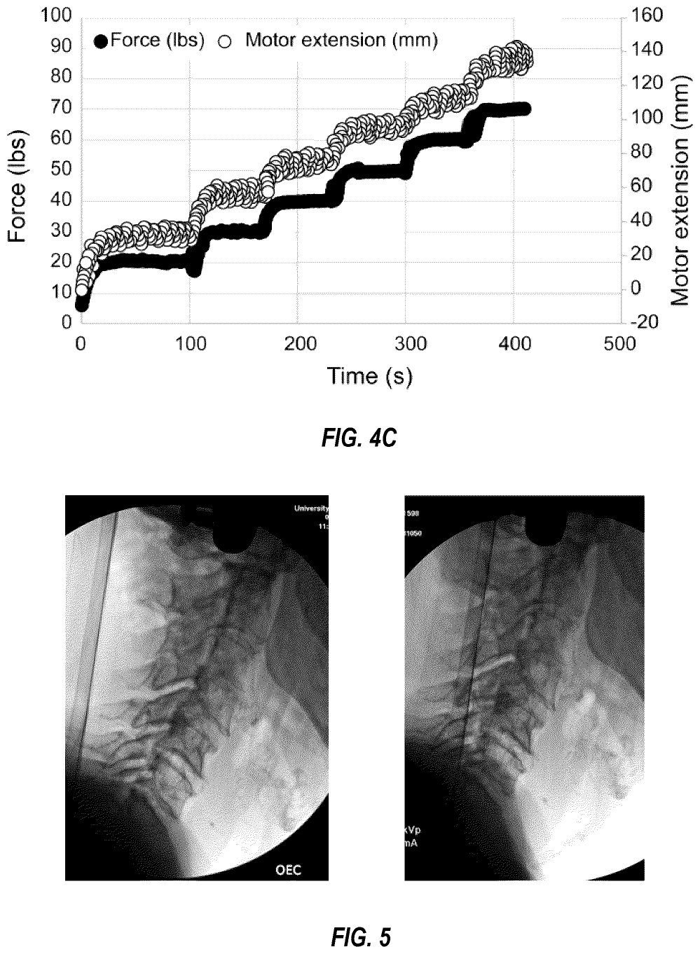

FIG. 4A shows the resulting force vs. time curve tested to 60 pounds and FIG. 4B shows the resulting force vs. time curve tested to 85 pounds. The data show that the cervical traction device achieved a substantially steady application of the target level of traction to the extension spring in relatively rapid fashion. In particular, the 60 pound test maintained a set value with a 1.5% fluctuation (±1.5 pound) and the 85 pound test maintained a set value with a 0.11% fluctuation (±1 pound).

Cadaveric Testing

An intact adult male fresh cadaver specimen with no known history of cervical spine trauma or cervical spine surgery was obtained. Before mechanical testing, a lateral radiograph was obtained to verify the absence of cervical spine instrumentation or bony injury. The cadaver was placed supine on a standard intensive care unit bed and placed in −20° of reverse Trendelenburg position. The cadaver was placed in Gardner-Wells tongs with the skull pins placed ˜1 cm above the vertex of the pinna bilaterally in line with external auditory meatus (not biased anteriorly or posteriorly). Skull pins were tightened until the spring-loaded indicator protruded 1 mm above flush surface.

First, manual weight-and-pulley traction was applied to the cadaver. Standard traction frame poles were attached to the patient bed. A pulley arm was attached to the crossbar of the traction frame. Traction rope was tied to the Gardner-Wells tongs and attached to hanging weighted plates on a hook. Manual traction was applied with the neck in a neutral position in 10 pound (45 N) increments starting at 0 pounds (0 N) up to 80 pounds (355 N) with lateral cervical radiographs captured at each interval using C-arm fluoroscopy.

After the manual traction procedure, the weights were released, and the pulley was removed from the traction frame crossbar. The cervical traction device 100 (as disclosed herein) was attached to the bed using standard traction frame poles with a crossbar. Traction rope was tied to the Gardner-Wells tongs and attached to an eye bolt threaded directly into the prototype load sensor. Motorized traction was assessed as in the manual traction tests.

FIG. 4C illustrates results of cadaveric mechanical testing, showing force (pounds) and actuator motor extension (mm) versus time up to 70 pounds (311 N) of traction applied in 10 pound (45 N) increments. The applied force and actuator displacement over time for the motorized cadaveric testing demonstrated that the device accurately applied the 10 pounds (45 N) traction force intervals and maintained substantially steady state forces between the intervals.

Comparison of the radiographs obtained during manual and motorized cervical traction showed that Intervertebral disc space measurements were within ±10% comparing motorized:manual traction ratio measurements for all levels. This is also illustrated by the comparative radiographic images of FIG. 5, which shows that radiographic alignment and distraction is essentially the same between the two methods (left image=motorized traction; right image=weight-pulley traction) at similar traction force.

### Additional Terms & Definitions

As used herein, anatomical directional and spatial terms such as “coronal plane,” “sagittal plane,” “inferior,” “superior,” “medial,” “lateral,” “anterior,” and “posterior” have their ordinary meaning as would be understood by one of skill in the art. When these terms are used in reference to the cervical traction device 100, they refer to the same spatial directions and planes that would exist in reference to a patient's head during use of the device (e.g., as shown in FIGS. 2A and 2B).

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

The embodiments disclosed herein should be understood as comprising/including disclosed components, and may therefore include additional components not specifically described. Optionally, the embodiments disclosed herein are essentially free or completely free of components that are not specifically described. That is, non-disclosed components may optionally be completely omitted or essentially omitted. For example, actuators, joints, connection mechanisms, frame components, patient attachment features, and/or controller components not specifically described herein may optionally be completely omitted or essentially omitted.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A cervical traction device, comprising:
an inferior base configured to attach to a patient support;
a superior base spaced apart from the inferior base along a cranial/caudal direction;
one or more linear actuators each comprising a first end attached to the inferior base and a second end attached to the superior base, each configured to extend so as to increase the distance of the superior base from the inferior base; and
an attachment point disposed on the superior base and configured to enable mechanical coupling of a patient head attachment to the superior base to enable cervical traction of a patient.

2. The cervical traction device of claim 1, wherein the device comprises two linear actuators laterally spaced from one another.

3. The cervical traction device of claim 1, further comprising a flexion/extension mechanism that enables rotational positioning of the one or more linear actuators relative to the inferior base along a direction substantially parallel to the sagittal plane.

4. The cervical traction device of claim 3, wherein the flexion/extension mechanism is motorized.

5. The cervical traction device of claim 3, wherein the flexion/extension mechanism comprises a keyed shaft, and wherein each of the one or more linear actuators are attached to a mount that includes a bore through which the keyed shaft passes.

6. The cervical traction device of claim 5, wherein the flexion/extension mechanism further comprises a lock configured to lock the rotational position of the shaft relative to the inferior base and thereby lock the rotational position of the one or more linear actuators relative to the inferior base.

7. The cervical traction device of claim 3, wherein the flexion/extension mechanism comprises one or more torsion springs configured to bias the flexion/extension mechanism toward a default rotational position.

8. The cervical traction device of claim 1, wherein each of the one or more linear actuators are attached to the superior base by a superior joint and wherein each of the one or more linear actuators are attached to the inferior base by an inferior joint, the superior and inferior joints being configured to enable lateral movement of the superior base relative to the inferior base along a direction substantially parallel to a coronal plane.

9. The cervical traction device of claim 8, wherein each linear actuator is connected to its superior joint via a pivot bracket comprising an arcuate slot inferior to the superior joint.

10. The cervical traction device of claim 1, further comprising a load sensor mechanically coupled to the attachment point.

11. The cervical traction device of claim 10, further comprising a controller communicatively coupled to the load sensor and to one or more motors corresponding to the one or more linear actuators, the controller being configured to receive load signals from the load sensor and to control force and/or displacement of the one or more linear actuators.

12. The cervical traction device of claim 11, wherein the controller is configured to lock the position of the one or more linear actuators upon detecting a change in force exceeding a predetermined safety threshold.

13. The cervical traction device of claim 11, wherein the controller is configured to actuate the one or more linear actuators according to a variable rate of traction force application and/or variable rate of linear actuator displacement.

14. The cervical traction device of claim 1, wherein the device is configured to apply at least 80 pounds of traction force and optionally up to 200 pounds of traction force.

15. The cervical traction device of claim 1, wherein the one or more linear actuators are locking linear actuators.

16. The cervical traction device of claim 1, further comprising the patient head attachment, wherein the patient head attachment comprises Gardner-Wells tongs or a Mayfield skull clamp.

17. A cervical traction device, comprising:
an inferior base configured to attach to a patient support;
a superior base spaced apart from the inferior base along a cranial/caudal direction;
a pair of laterally spaced linear actuators each configured to extend so as to increase the distance of the superior base from the inferior base and each comprising
a first end attached to the inferior base via an inferior joint, and
a second end attached to the superior base via a superior joint,
the superior and inferior joints being configured to enable lateral movement of the superior base relative to the inferior base along a direction parallel to a coronal plane;
an attachment point disposed on the superior base and configured to enable mechanical coupling of a patient head attachment to the superior base to enable cervical traction of a patient.

18. The cervical traction device of claim 17, further comprising a flexion/extension mechanism that enables rotational positioning of the one or more linear actuators relative to the inferior base along direction substantially parallel to a sagittal plane.

19. The cervical traction device of claim 18, wherein the flexion/extension mechanism is motorized.

20. A cervical traction device, comprising:
an inferior base configured to attach to a patient support;
a superior base spaced apart from the inferior base along a cranial/caudal direction;
a pair of laterally spaced linear actuators each configured to extend so as to increase the distance of the superior base from the inferior base and each comprising
a first end attached to the inferior base, and
a second end attached to the superior base;
an attachment point disposed on the superior base and configured to enable mechanical coupling of a patient head attachment to the superior base to enable cervical traction of a patient; and
a flexion/extension mechanism that enables rotational positioning of the one or more linear actuators relative to the inferior base along a direction substantially parallel to a sagittal plane.
